(19) United States
(12) Patent Application Publication
(10) Pub. No.: US 2022/0092455 A1
(43) Pub. Date: Mar. 24, 2022

(54) DATA ANALYSIS DEVICE, METHOD, AND PROGRAM

(71) Applicant: NIPPON TELEGRAPH AND TELEPHONE CORPORATION, Tokyo (JP)

(72) Inventors: Masahiro KOJIMA, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/421,693

(22) PCT Filed: Jan. 7, 2020
(86) PCT No.: PCT/JP2020/000124

§ 371 Date: Jul. 8, 2021

(30) Foreign Application Priority Data
Jan. 11, 2019 (JP) 2019-003817

(51) Int. Cl. G06N 7/00; G06K 9/62

(52) U.S. Cl. CPC G06N 7/005; G06K 9/6298; G06K 9/6215

(57) ABSTRACT

There are provided a data analysis device, a method, and a program that are capable of improving the accuracy of predicting an output variable for an unknown input variable by making it possible to use input/output data in which the value of the output variable is given as an interval value. A data analysis device 10A includes: a data processing unit 12 that performs a process of acquiring data represented by a set of a plurality of first input/output data in which a value of an output variable is given and a plurality of second input/output data in which a value of an output variable is gives as an interval value representing a range; and a prediction unit 16 that, based on an input variable for which a value of an output variable is unknown and the data, predicts a value of an output variable for the unknown input variable using a Gaussian process.

### TECHNICAL FIELD

The present invention relates to a data analysis device, a method, and a program.

### BACKGROUND ART

In a regression problem of predicting the value of an output variable y from an input variable x, an approach called a Gaussian process (GP) is widely used, which is described in Reference 1 (Carl Edward Rasmussen and Christopher K. I. Williams. Gaussian Processes for Machine Learning. The MIT Press, 2005.). This is an approach that can perform regression by defining a function called a kernel that calculates a value corresponding to similarity between input variables, and not only vectors but also various things such as graphs, images and documents can be used as input variables by defining a kernel appropriately.

On the other hand, a regression problem in recent data analysis needs a technique for handling data in which an output variable is given not as an exact value but as an interval value representing the range of the value. As an example, consider a situation in which the number of passed persons or vehicles is measured manually or through a camera. At this time, for example, if there is a time when an exact value, could not be measured due to carelessness of a person, the number of passed vehicles at that time may only be known as a range that can be answered from memory, such as “3 or more and 10 or less”. Similarly, if there is a limit on the measurable number of persons due to camera requirements (e.g., 10 persons/second), the number of passed persons at the time when a number of persons exceeding the limit have passed can only be known as “10 persons or more”.

FIG. 7 is a diagram showing an example of data in which an output variable is given as an interval value.

In FIG. 7, the vertical axis represents the number of passed persons per unit time, and the horizontal axis represents the time.

Although FIG. 7 shows a situation in which an input variable is given as a real value, a wide variety of input variables are possible in a Gaussian process as described above, and it is not limited to this example. Further, when the input variable is a real value, it is possible to consider the case where the input variable is also given as an interval value, but in that case as well, for example, the method described in Non-Patent Literature 1 can be used to estimate the true scalar value of the interval value in advance, thereby obtaining data in which only the output variable is Given as an interval value.

Conventional regression based on a Gaussian process cannot be applied to data in which an output variable is represented by an interval value, but for example, there is an approach of Kashima et al. (see, e.g., Non-Patent Literature 2)that uses an output variable represented by an interval value to perform linear regression (instead of a Gaussian process). This approach introduces a latent variable that represents the true value of the output variable given as an interval value, and performs estimation by an EM (expectation maximization) algorithm, that is, an EM algorithm that repeats updating the latent variable and the parameters of linear regression.

### CITATION LIST

### Non-Patent Literature

Non-Patent Literature 1: Masahiro Kohjima, Tatsushi Matsubayashi, and Hiroyuki Toda. Variational Bayes for mixture models with censored data. In ECMLPKDD, 2018.

Non-Patent Literature 2: Hisashi Kashima, Kazutaka Yamasaki, Akihiro Inokuchi, and Hiroto Saigo. Regression with interval output values. In Pattern Recognition, 2008. ICPR 2008. 19th International Conference on, pp. 1-4. IEEE, 2008.

### SUMMARY OF THE INVENTION

### Technical Problem

However, since the above approach is not an approach based on a Gaussian process using a kernel, graphs, images, documents, etc. cannot be used as input variables. Further, the accuracy may decrease if a feature amount used in linear regression is not designed.

The present invention has been made in view of the above circumstances, and aims to provide a data analysis device, a method, and a program that are capable of improving the accuracy of predicting an output variable for an unknown input variable by making it possible to use input/output data in which the value of the output variable is given as an interval value.

### Means for Solving the Problem

In order to achieve the above object, a data analysis device according to the first invention includes: a data processing unit that performs a process of acquiring data represented by a set of a plurality of first input/output data in which a value of an output variable is given and a plurality of second input/output data in which a value of an output variable is given as an interval value representing a range; and a prediction unit that, based on an input variable for which a value of an output variable is unknown and the data, predicts a value of an output variable for the unknown input variable using a Gaussian process.

Further, the data analysis device according to the second invention, in the data analysis device according to the first invention, further includes a latent variable estimation unit that estimates a latent variable representing an estimate of a true value of an output variable given as the interval value for each of the second input/output data, the latent variable estimation unit generating a random number as the latent variable according to a truncated normal distribution of a generation probability of a latent variable conditioned by the interval value, the truncated normal distribution being represented using a kernel function that represents similarity between input variables of the first input/output data, a kernel function that represents similarity between an input variable of the first input/output data and an input variable of the second input/output data, a kernel function that represents similarity between input variables of the second input/output data, and the interval value, wherein the prediction unit predicts a value of an output variable for the unknown input variable according to a predictive distribution represented using a Gaussian distribution that represents a posterior probability of an output variable for the unknown input variable given a value of the output variable of each of the first input/output data and the latent variable of each of the second input/output data.

Further, the data analysis device according to the third invention, in the data analysis device according to the first invention, further includes a latent variable estimation unit that estimates a mean and variance of a value of the output variable of each of the second input/output data based on a truncated normal distribution of a generation probability of a value within the interval value of each of the second input/output data, the truncated normal distribution being represented using a kernel function that represents similarity between input variables of the first input/output data, a kernel function that represents similarity between an input variable of the first input/output data and an input variable of the second input/output data, a kernel function that represents similarity between input variables of the second input/output data, and the interval value, wherein the prediction unit predicts a value of an output variable for the unknown input variable according to a predictive distribution representing a posterior probability of an output variable for the unknown input variable given a value of an output variable of each of the first input/output data and a value conditioned by the interval value of each of the second input/output data, the predictive distribution being represented using a normal distribution of a value of the output variable of each of the second input/output data, based on a normal distribution obtained from a mean and variance of a value of the output variable of each of the second input/output data.

Further, in the data analysis device according to the fourth invention, in the data analysis device according to the first invention, the prediction unit predicts a value of an output variable for the unknown input variable according to a predictive distribution representing a posterior probability of an output variable for the unknown input variable given a value of an output variable of each of the first input/output data and a value conditioned by the interval value of each of the second input/output data, the predictive distribution being represented using a posterior probability of a latent interval value for the unknown input variable given a value of an output variable of each of the first input/output data and the interval value of each of the second input/output data, and a posterior probability of a value of an output variable for the unknown input variable given a posterior probability of a latent interval value for the unknown input variable based on a kernel function for an upper limit of the interval value that represents similarity between input variables of the second input/output data, and a kernel function for a lower limit of the interval value that represents similarity between input variables of the second input/output data.

Further, in the data analysis device according to the fifth invention, in the data analysis device according to the first invention, the prediction unit sets a value of an output variable of each of the first input/output data to an upper limit and a lower limit of an interval value of an output variable of each of the first input/output data, and predicts a value of an output variable for the unknown input variable according to a predictive distribution representing a posterior probability of an output variable for the unknown input variable given a value of an output variable of each of the first input/output data and a value conditioned by the interval value of each of the second input/output data, the predictive distribution being represented by a normal distribution that is represented using: a mean that is determined from: a mean represented using a kernel function for an upper limit of the interval value that represents similarity between the unknown input variable and each of input variables of the first input/output data and the second input/output data, a kernel function for an upper limit of the interval value that represents similarity between input variables of the first input/output data and the second input/output data, and an upper limit of an interval value of an output variable of each of the first input/output data and the second input/output data; and a mean represented using a kernel function for a lower limit of the interval value that represents similarity between the unknown input variable and each of input variables of the first input/output data and the second input/output data, a kernel function for a lower limit of the interval value that represents similarity between input variables of the first input/output data and the second input/output data, and a lower limit of an interval value of an output variable of each of the first input/output data and the second input/output data; and a variance that is represented using a kernel function that represents similarity between input variables of the first input/output data and the second input/output data.

On the other hand, in order to achieve the above object, a data analysis device according to the sixth invention includes: a data processing unit that performs a process of acquiring data represented by a set of a plurality of first input/output data in which a value of an output variable is given and a plurality of second input/output data in which a value of the output variable is given as an interval value representing a range; and a prediction unit that, based on an input variable for which a value of an output variable is unknown and the data, predicts a value of an output variable for the unknown input variable using linear regression, wherein the prediction unit predicts a value of an output variable for the unknown input variable according to a predictive distribution representing a posterior probability of an output variable for the unknown input variable, the predictive distribution being represented by a normal distribution that is represented based on a linear regression parameter that represents relationship between an input variable and an upper limit of an interval value of an output variable, a linear regression parameter that represents relationship between an input variable and a lower limit of an interval value of an output variable, a weight parameter for each or an upper limit and a lower limit of an interval value, and a variance parameter, which are estimated based on the first input/output data an the second input/output data, using a mean that is determined from a mean calculated from the unknown input variable using a linear regression parameter that represents relationship with an upper limit of the interval value, a mean calculated from the unknown input variable using a linear regression parameter that represents relationship with a lower limit of the interval value, and the weight parameter, and a variance that is represented using the weight parameter and the variance parameter.

On the other hand, in order to achieve the above object, a data analysis method according to the seventh invention includes: a step of a data processing unit performing a process of acquiring data represented by a set of a plurality of first input/output data in which a value of an output variable is given and a plurality of second input/output data in which a value of an output variable is given as an interval value representing a range; and a step of a prediction unit predicting, based on an input variable for which a value of an output variable is unknown and the data, a value of an output variable for the unknown input variable using a Gaussian process.

Further, in order to achieve the above object, a program according to the eighth invention causes a computer to function as each unit provided in the data analysis device according to any one of the first to sixth inventions.

### Effects of the Invention

As described above, according to the data analysis device, the method, and the program of the present invention, the accuracy of predicting an output variable for an unknown input variable can be improved by making it possible to use input/output data in which the value of the output variable is given as an interval value.

Further, by taking an approach using kernels, it is possible to handle more diverse data as input than linear regression.

Furthermore, it is not necessary to design a feature amount which would be required in linear regression, and accurate estimation can be performed.

### BRIEF DESCRIPTION OF DRAWINGS

FIG. 1 is a diagram showing an example of a Gaussian process using a latent variable.

FIG. 2 is a diagram showing an example of an interposed Gaussian process.

FIG. 3 is a block diagram showing an example of a functional configuration of a data analysis device according to a first embodiment.

FIG. 4 is a flowchart showing an example of a processing flow by a data analysis processing program according to the first embodiment.

FIG. 5 is a block diagram showing an example of a functional configuration of a data analysis device according to a second embodiment.

FIG. 6 is a flowchart showing an example of a processing flow by a data analysis processing program according to the second embodiment.

FIG. 7 is a diagram showing an example of data in which an output variable is given as an interval value.

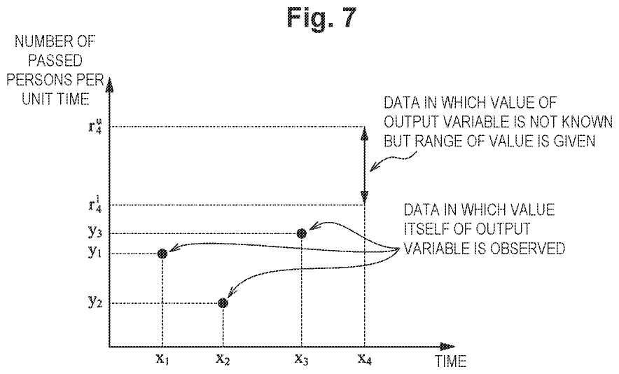

### DESCRIPTION OF EMBODIMENTS

Hereinafter, example embodiments for carrying out the present invention will be described in detail with reference to the drawings.

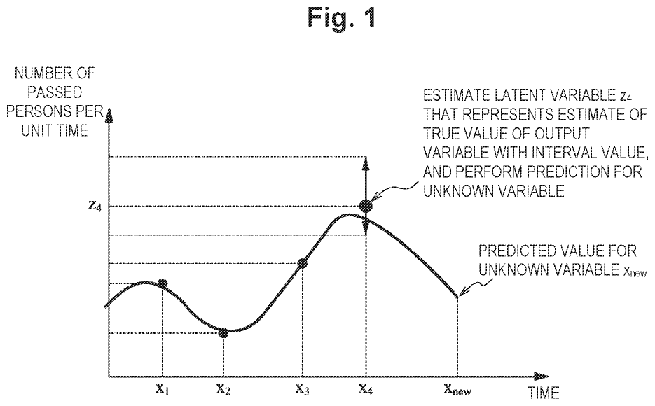

These embodiments show two algorithms based on a Gaussian process using an interval value output. As shown in FIG. 1, the first approach is an approach that introduces a latent variable representing the true value of the output variable given as an interval value, similar to the approach of Kashima et al. (Non-Patent Literature 2).

FIG. 1 is a diagram showing an example of a Gaussian process using a latent variable.

In FIG. 1, the vertical axis represents the number of passed persons per unit time, and the horizontal axis represents the time.

In FIG. 1, a latent variable Z₄ that represents an estimate of the true value of an output variable with an interval value is estimated, and an output variable for an unknown input variable is predicted.

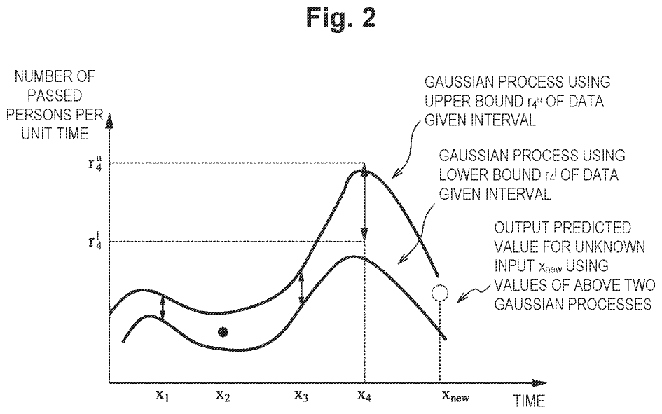

Next, the second approach is an approach that uses predicted values from two Gaussian processes as shown in FIG. 2. That is, this second approach uses “a Gaussian process using the upper bound of data with an interval value” and “a Gaussian process using the lower bound of data with an interval value”. Hereinafter, a method using the two Gaussian processes will be referred to as “interposed Gaussian process”.

FIG. 2 is a diagram showing an example of an interposed Gaussian process.

In FIG. 2, the vertical axis represents the number of passed persons per unit time, and the horizontal axis represents the time.

In FIG. 2, a Gaussian process using the upper bound r₄^{u} of data given an interval and a Gaussian process using the lower bound r₄^{l} of the data given the interval are used. Then, the values of these two Gaussian processes are used to predict the output variable for an unknown input variable x_{new}.

Each of these two algorithms has its strengths and weaknesses. When the first approach is used, data with an interval value can be handled even if it is unbounded (e.g., data that is known to be 10 or more but has an unknown upper bound, and can only be said to be smaller than infinity). Instead, it is necessary to use computationally expensive latent variable sampling or some approximation before prediction. On the other hand, when the second approach is used, contrary to the case of the first approach, data with an interval value cannot be handled unless it is bounded (e.g., the range is clearly known, such as 10 or more and 15 or less). Instead, a predicted value can be output without performing latent variable sampling or approximation before prediction.

### Definition of Data

It is assumed that data D has been given that is represented by a set of s pieces of input/output data in which the exact value of an output variable is known and t pieces of input/output data in which the exact value of the output variable is not known but the range taken by the value is known:

[symbol]

={xᵢ,yᵢ}ᵢ₌₁^{s}∪

{xⱼ,rⱼ^{u}, [symbol] }ⱼ₌₁^{t}

xᵢ denotes the input variable of data i, and yᵢ, denotes the output variable (whose value is known) of the data i. xⱼ denotes the input variable of data j, rⱼ^{l} denotes the lower bound of the value taken by the output variable of the data j, and rⱼ^{u} denotes the upper bound of the value taken by the output variable of the data j. Data that is given exact data as an output variable is indicated by an index i∈Ωₛᵥ, and data that is given as an interval value indicating the range of the value is indicated by an index j∈Ωᵢᵥ. The total number of the data is written as n (=s+t), and an index d is used when no distinction is made between the above two types of data. Further, the output variables with scalar values are hereinafter collectively written as:

y^{s}={yᵢ}_{i∈Ω}_{ₛᵥ}

and the variables indicating the range of the output variable with an interval value are written as:

r^{u}{rⱼ^{u}}_{j∈Ω}_{ᵢᵥ}, [symbol] ={ [symbol] }_{j∈Ω}_{ᵢᵥ}

Further, as a latent variable, a variable yⱼ^{t} is introduced that indicates the value of the output variable of data j in which the value of the output variable is unknown. That is, yⱼ^{t} satisfies:

[symbol]

≤yⱼ^{t}≤rⱼ^{u}

These are also collectively written as:

y^{t}={yⱼ^{t}}_{j⊂Ω}_{ᵢᵥ}

Furthermore, y^{s} and y^{t} are collectively written as:

y={y_{d}}_{d=1}ⁿ

### 1. Gaussian Process Using Latent Variable

The first algorithm described above, that is, a method based on a Gaussian process using a latent variable will be described here. In this method, a model as described below is considered as a process of generating the output variable y.

First, it is assumed that a function f that defines input/output relationship follows a Gaussian process. When f as a Gaussian process, any subset:

f={f_{d}(=ƒ(x_{d}))}_{d=1}ⁿ

follows the following Gaussian distribution:

P(f)=N(f|0,Kₙₙ).

Here, Kₙₙ is an n×n variance-covariance matrix, in which the (d, d′) element k_{dd′}is expressed using a kernel function:

k(*,*)

as k(x_{d}, x_{d′}).

Next, it is assumed that the output variable follows an isotropic Gaussian distribution with the mean f:

$$P ( y \vert f ) = ( y \vert f , {σ}^{2} {I}_{n} ) = {\prod }_{d = 1}^{n} ( {y}_{d} \vert {f}_{d} , {σ}^{2} ) .$$

Here, In denotes an n×n identity matrix. If f is integrated out, it can be seen that the generation probability of y is given by the following expression:

P(y)=∫P(f)N(y|f,σ²)df=N(y|0,Cₙₙ). (1)

Here, the definition Cₙₙ=Kₙₙ+σ²Iₙ is made. From the nature of a conditional distribution of a Gaussian distribution, the posterior probability of the output variable y* for an unknown input variable x* given y is given by the following Gaussian distribution:

P(y_{*}|y)= [symbol] (y_{*}|m(x_{*}), C(x_{*},x_{*})),

m(x)=kₓ^{T}Cₙₙ⁻¹y,C(x,x′)=k(x,x′)−kₓ^{T}Cₙₙ⁻¹k_{x′} (2)

kₓ is an n-row vector defined as:

kₓ(k(x*,x₁), . . . ,k(x*,xₙ).

In the case of a normal regression problem in which all the values of the output variables are known, prediction can be performed using Expression (2) described above. However, in this problem setting, since the value of the output variable yₜ of the data that is given only the interval value is unknown, it is not possible to make a prediction as it is. Therefore, P (y) is further broken down and examined in more detail.

Similar to Expression (1), the generation probability of P (y^{s}) that is limited only to the data in which the output variable is given as a scalar value is as follows:

P(y^{s})=∫P(f^{s})N(y^{s}|f^{s},σ²)df^{s}=N(y^{s}|0,Cₛₛ).

Here, and Cₛₛ=Kₛₛσ²Iₙₛᵥ, and Kₛₛ is an s×s matrix in which the (i, i′) element (i, i′∈Ωₛᵥ) is k(xᵢ,x_{i°}). Furthermore, the probability of y^{t} given y^{s} is as follows:

P(y^{t}|y^{s})= [symbol] (y^{s}|m_{t|s},C_{t|s}),

m_{t|s}=Kₛₜ^{T}Cₛₛ⁻¹y^{s}C_{t|s}=Kₜₜ−Kₜₜ−Kₛₜ^{T}Cₛₛ⁻¹Kₛₜ.

Here, Kₜₜ is a t×t matrix, in which the (j, j′) element (j, j′∈Ωᵢᵥ) is defined by k(xⱼ,x_{j′}), and Kₛₜ is an s×t matrix, in which the (i, j′) element (i∈Ωₛᵥ, j∈Ωᵢᵥ) is defined by k(xᵢ, xⱼ).

Accordingly, the probability:

P(yᵢᵥ∈(l,u)|yₛᵥ)

that each element yⱼ of yᵢᵥ takes a value in the interval:

( [symbol] ,rⱼ^{u})

is:

P(y^{t}∈( [symbol] ,r^{u})|yₛᵥ)= [symbol] [symbol] (y^{t}|m_{t|s},C_{t|s})dyᵢᵥ

and the generation probability of the latent variable y^{t} conditioned by the interval value is given by the following expression:

P(y^{t}|y^{t}∈(r^{l},r^{u}),y^{s})=TN(y^{t}|m_{t|s},C_{t|s},r^{l},r^{u}). (3)

Here, TN denotes a multi-dimensional truncated normal distribution, and its probability density function is given by the following expression:

$$( x \vert μ , Σ , a , b ) = \{ \begin{matrix}\frac{𝒩 ( x \vert μ , Σ )}{{\int }_{x ∈ ( a , b )} 𝒩 ( x \vert μ , Σ ) dx} & ( if x ∈ ( a , b ] ) \\ 0 & ( otherwise ) \end{matrix}$$

From the above derivation, the posterior probability of the output variable y* for the unknown input variable x* given y^{t}∈(r^{l}, r^{u}) and y^{s} is given using Expressions (2) and (3) described above as:

P(y*|y^{t}∈(r^{l},r^{u}),y^{s})==∫P(y*|y)P(y*|y^{t}∈(r^{l},r^{u}),y^{s})dy^{t}=∫N(y*|m(x*),C(x*,x*))TN(y^{t}|m_{t|s},C_{t|s}l,u)dy^{t}. (4)

Since it is difficult to analytically calculate the integral with respect to y^{t}, constructing a predictive distribution requires a method of numerically obtaining it by generating random numbers, or an approach using approximation by a normal distribution, as described below.

### 1-1. Method of Generating Random Numbers

In this method, by generating Q random number-generated values:

y^{t(l)}, . . . ,y^{t(Q)}

that are random numbers following the truncated normal distribution in Expression (3) described above,

and using the defined:

y^{(q)}=(y^{s},y^{t(q)})

and using, as an approximation of Expression (4):

$$P ( {y}_{*} \vert {y}^{t} ∈ ( , {r}^{u} ) {y}^{s} ) \approx {\sum }_{q = 1}^{Q} P ( {y}_{*} \vert {y}^{( q )} ) \qquad ( 5 )$$

the predictive distribution can be constructed. A method of generating random numbers following a truncated normal distribution is described in Reference 2 (Stefan Wilhelm and B G Manjunath. tmvtnorm: A package for the truncated multivariate normal distribution. sigma, Vol. 2, No. 2, 2010.) as an example.

### 1-2. Method Using Approximation by Normal Distribution

In this method, the predictive distribution is constructed by approximating the truncated normal distribution with a normal distribution. For example, when variational approximation and moment matching are used, variational approximation is first used to approximate the multi-dimensional truncated normal distribution in Expression (3), so that a truncated normal distribution that is independent in each dimension can be obtained.

For example, as in an approach described in Reference 3 (N L. Johnson, S. Kotz, and N. Balakrishnan. Continuous Univariate Probability Distributions, (Vol. 1). John Wiley & Sons Inc., NY, 1994.) , it is known that the mean and variance of a one-dimensional truncated normal distribution can be obtained analytically. Therefore, approximation becomes possible using a normal distribution that has them as its mean and variance via moment matching. By using this approximate distribution, the integral in the expression of the predictive distribution can be solved analytically, so that the predictive distribution can be constructed.

### 2. Interposed Gaussian Process

As the second algorithm, a method using two regression analyses will be described. First, an interposed linear regression approach will be described, which is a linear regression version of a method using two Gaussian processes. This interposed linear regression approach is also a method newly proposed by this embodiment.

### 2-1. Interposed Linear Regression

Modeling is performed by assuming that the upper and lower bounds of the interval value:

r_{d}=(r_{d}^{u}, [symbol] )

and the scalar value y_{d} for an input x_{d} have been obtained according to the following normal distributions:

P(r_{d}^{u}|x_{d},wᵤβ)= [symbol] (r_{d}^{u}|wᵤ^{T}Φ(x_{d}),β⁻¹),P( [symbol] x_{d}, [symbol] , [symbol] )= [symbol] ( [symbol] | [symbol] Φ(x_{d}),β⁻¹),P(y_{d}|r_{d},α)=δ(y_{d}−α^{T}r_{d}).

Here,

W=(wᵤ,wₗ,α=(αᵤ,αₗ)

denote parameters to be estimated, β denotes a parameter to be estimated, φ(*) denotes a known function that defines a feature amount, and δ(*) denotes the delta function. Note that as described in the above definition of data, if d∈Ωₛᵥ, the scalar value y_{d} has been observed but the interval value r_{d} has not been observed, or if d∈Ωᵢᵥ, the scalar value has not been observed but the interval value has been observed. Using the property that the sum of normal distributions is a normal distribution, the interval value r_{d} in the case where only the scalar value is observed can be marginalized out as follows:

$$\begin{matrix}P ( {y}_{d} \vert {x}_{d} , W , α , β ) = \int \int δ ( {y}_{d} - {α}^{T} {r}_{d} ) P ( {r}_{d}^{u} \vert {x}_{d} , {w}_{u} , \\ β ) P ( \vert {x}_{d} , {w}_{ℓ} , β ) {dr}_{d}^{u} \\ = ( {y}_{d} ϕ ( {x}_{d} ) + {α}_{u} {w}_{u}^{T} ϕ ( {x}_{d} ) , ( + {α}_{n}^{2} ) {β}^{- 1} )\end{matrix} \qquad ( 6 a )$$

Using this result, the generation probability of data given the parameters can be organized as follows:

$$P ( \vert W , α , β ) = {Π}_{i ∈ {Ω}_{*}} P ( {y}_{i} \vert {x}_{i} , W , α , β ) {Π}_{j ∈ {Ω}_{*}} P ( {r}_{j}^{u} \vert {x}_{j} , {w}_{u} , β ) P ( \vert {x}_{j} , , β ) {\prod }_{d = 1}^{n} u ( {x}_{d} )$$

Therefore, the parameters can be estimated by maximizing the following logarithmic objective function with respect to the parameters W, α, and β:

L(W,α,β)=log P(D|W,α,β).

### 2-2. Interposed Gaussian Regression

The function that defines the input/output relationship between the input variable and the upper bound of the interval value is written as f^{u}, and the function that defines the input/output relationship between the input variable and the lower bound of the interval value is written as f^{l}. It is assumed that each of f^{u} and f^{l} follows a Gaussian process. Therefore, any subsets:

f^{u}={f_{d}^{u}(=ƒ^{u}(x_{d}))}_{d-1}ⁿ and [symbol] ={ [symbol] (= [symbol] (x_{d}))}_{d=1}ⁿ

follow the following Gaussian distributions:

P(f^{u})N(f|0,K^{u}),P(f^{l})=N(f|0,K^{l}).

Here, K^{u} and K^{l} are variance-covariance matrices, and their elements are respectively expressed by kernel functions:

k*(*,*),k^{l}(*,*).

Furthermore, it is assumed that the upper bound y^{u} and the lower hound y^{l} of the interval value follow isotropic Gaussian distributions having the means f^{u} and f^{l}, respectively:

P(r^{u}|f^{u})=N(r^{u}|f^{u}σ²I),P(r^{l}|f^{l})=N(r^{l}|fⁱ,σ²I).

If f^{u} and f^{l} are integrated out, the result is as follows

P(r^{u})=N(r²|0,K^{u}+σ²I),P(r^{l})=N(r^{l}|0,K^{l}+σ²I).

Finally, it is assumed that the scalar value y follows the following normal distribution:

P(y|r^{l},r^{u};α)=N(y|α^{T}r,γ⁻¹I). (6c)

If a set of latent interval value data in the data i∈Ωₛᵥ in which only the scalar value is observed is written as z^{u} and z^{l} (which are not observed), the generation process of y, r^{l}, and r^{u} can be written as

P(y,r^{l},r^{u};α)=∫∫P(y|z^{u},z^{l};α)P(z^{u},r^{u})P(z^{l},r^{l})dz^{u}dz^{l}.

The integral in the expression can be calculated analytically, and

P(y,r^{l},r^{u};α)

becomes a normal distribution. α, σ², and γ⁻¹ can be estimated by maximizing this as an objective function. The predicted value y* for the unknown variable can be derived by the following expression using a normal method of constructing a predictive distribution in a Gaussian process and Expression (6c) described above:

P(y_{*}|y,r^{u}, [symbol] )=∫∫P(y_{*}|r_{*}^{u}, [symbol] )P(r_{*}^{u}, [symbol] |y,r^{u}, [symbol] )dr^{u} [symbol] (7)

Note that although a simple linear Gaussian model using Expression (6c) is considered here, this itself may be a Gaussian process, or a model that takes into account up to higher-order terms may be considered.

### 2-3. Interposed Gaussian Regression. (When Scalar Value is Treated as Interval Value)

Although this approach is almost the same as the method of [2-2. Interposed Gaussian Regression] described above, the approach can also be constructed more simply by treating a scalar value as an interval value with a length of zero. For simplification of notation, here, the scalar value and the upper bound of the interval value of the output variable are collectively written as y^{u}, and the scalar value and the lower bound of the interval value of the output variable are collectively written as y^{l}. That is:

y^{u}={yᵢ}_{i∈Ω}_{ₛᵥ}∪{rⱼ^{u}}_{j∈Ω}_{ᵢᵥ},

[symbol]

={yᵢ}_{i∈Ω}_{ₛᵥ}∪{ [symbol] }_{i∈Ω}_{ᵢᵥ}

The function that defines the input/output relationship between the input variable and the upper bound of the interval value is written as f^{u}, and the function that defines the input/output relationship between the input variable and the lower bound of the interval value is written as it is assumed that each of f^{u} and f^{l} follows a Gaussian process. Therefore, any subsets:

f^{u}={f_{d}^{u}(=ƒ^{u}(x_{d}))}_{d=1}ⁿ and [symbol] ={ [symbol] (= [symbol] (x_{d}))}_{d=1}ⁿ

follow the following Gaussian distributions:

P(f^{u})=N(f|0,K^{u}),P(f^{l})=N(f|0,K^{l}).

Furthermore, it is assumed that the output variables y^{u} and y^{l} follow isotropic Gaussian distributions having the means f^{u} and f^{l}, respectively,

P(y^{u}|f^{u})=N(y^{u}|f^{u},Ω²I),P(y^{l}|f^{l})=N(y^{l}|f^{l},Ω²I).

if f^{u} and f^{l} are integrated out,

P(y^{u})=N(y^{u}|0,C^{u}),P(y^{l})=N(y^{l}|0,C^{l}).

Here,

C^{u}=K^{u}+Ω²I,C^{l}=K^{l}+Ω²I.

Therefore, the predictive distributions of the output variables

y_{*}^{u} and

[symbol]

for the unknown input variable x* are given by the following Gaussian distributions:

P(y_{*}^{u}|y^{u})= [symbol] (y_{*}^{u}|m^{u}(x_{*}),C^{u}(x_{*},x_{*})),P( [symbol] | [symbol] )= [symbol] ( [symbol] | [symbol] (x_{*}),C(x_{*},x_{*}))

m^{u}(x)=k^{T}(C^{u})⁻¹y^{u}, [symbol] (x)=k^{T}( [symbol] )⁻¹ [symbol] ,

C^{u}(x,x′)=k^{u}(x,x′)−kₓ^{uT}(C^{u})⁻¹k_{x′}^{u}, [symbol] (x,x′)= [symbol] (x,x′)− [symbol] ( [symbol] )⁻¹ [symbol] , (8)

Here,

kₓ^{u},

[symbol]

are n-row vectors defined as:)

kₓ^{u}=(k^{u}(x_{*},xₗ), . . . , k^{u}(x₈,xₙ)), [symbol] =( [symbol] (x_{*},xₗ), . . . , [symbol] (x_{*},xₙ))

Therefore, since the predictive distributions of the upper and lower bounds of the output variable for any input variable can be calculated by Expression (8), prediction can be performed by assuming that the output variable value is determined by the weighted sum of these two:

P(y_{*}|y_{*}^{u}, [symbol] )=δ(y_{*}−(αy_{*}^{u}+ [symbol] )) (9)

α and β are variables representing weights. However, unlike the method of [2-2. Interposed Gaussian Regression] described above, in the method of treating a scalar value as an interval value, it is necessary to use a cross-validation method or the like for estimation of these α and β. If there is prior knowledge on the value, for example, if the scalar value is roughly the mean of the upper and lower bounds, α=β=½ should be set based on that knowledge. Note that since a linear sum of variables following normal distributions also follows a normal distribution, the posterior distribution of y* is also given by a normal distribution. The posterior distribution when α=β=½ is as follows:

$$\begin{matrix}P ( {y}_{*} \vert {y}^{u} , ) = \int \int P ( {y}_{*} \vert {y}_{*}^{u} , ) P ( {y}_{*}^{u} \vert {y}^{u} ) P ( {y}_{*}^{ℓ} \vert {y}^{ℓ} ) ) {dy}_{*}^{u} \\ = ( {y}_{*} \vert \frac{{m}^{u} ( {x}_{*} ) + ( {x}_{*} )}{2} , \frac{C ( x , {x}_{*} )}{2} ) .\end{matrix} \qquad ( 10 )$$

By using the above approach, it becomes possible to use the value of the output variable as data regardless of whether it is an observed value itself or is given by an interval value representing the range taken by the value. Therefore, the accuracy of prediction can be improved as compared with conventional Gaussian processes.

### First Embodiment

In this embodiment, a data analysis device in the case of implementing the first approach in which a latent variable is introduced will be described. Note that either [1-1. Method of Generating Random Numbers] or [1-2. Method Using Approximation by Normal Distribution] is applied to the estimation of the latent variable.

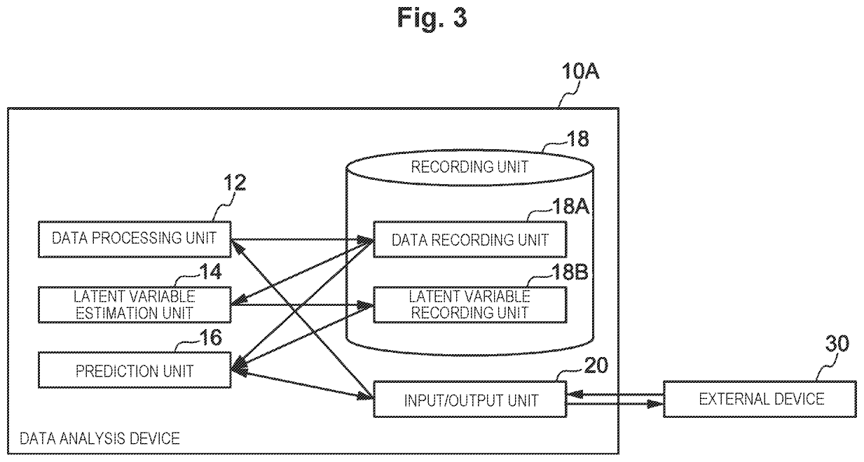

FIG. 3 is a block diagram showing an example of a functional configuration of a data analysis device 10A according to the first embodiment.

As shown in FIG. 3, the data analysis device 10A according to this embodiment is provided with a data processing unit 12, a latent variable estimation unit 14, a prediction unit 16, a recording unit 18, and an input/output unit 20.

The data analysis device 10A is electrically configured as a computer device provided with a CPU (central processing unit), a RAM (random access memory), a ROM (read-only memory), and the like. Note that a data analysis processing program according to this embodiment is stored in the ROM.

The above data analysis processing program may, for example, be pre-installed in the data analysis device 10A. This data analysis processing program may be implemented by storing it in a non-volatile storage medium or distributing it via a network to appropriately install it in the data analysis device 10A. Note that examples of non-volatile storage media include a CD-ROM (compact disc read only memory), a magneto-optical disk, a DVD-ROM (digital versatile disc read only memory), a flash memory, a memory card, and the like.

For example, a non-volatile storage device is applied to the recording unit 18. The recording unit 18 is provided with a data recording unit 18A and a latent variable recording unit 18B.

The input/output unit 20 is connected to an external device 30 via a network, receives input of data to be analyzed from the external device 30, and outputs the analyzed data to the external device 30.

The CPU functions as the data processing unit 12, the latent variable estimation unit 14, and the prediction unit 16 described above by reading and executing the data analysis processing program stored in the ROM.

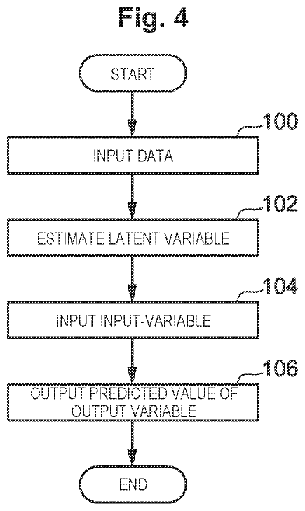

Next, the operation of the data analysis device 10A according to the first embodiment will be described with reference to FIG. 4. Note that FIG. 4 is a flowchart showing an example of a processing flow by the data analysis processing program according to the first embodiment.

In step 100 of FIG. 4, the data processing unit 12 acquires the data D described above from the external device 30 via the input/output unit 20, and stores it in the data recording unit 18A. Note that the data D is defined as data represented by a set of a plurality of first input/output data in which the value of the output variable is given and a plurality of second input/output data in which the value of the output variable is given as an interval value representing a range.

In step 102, the latent variable estimation unit 14 uses the data D stored in the data recording unit 18A as input, estimates a latent variable representing an estimate of the true value of the output variable given as an interval value for each of the plurality of second input/output data, and stores the estimated latent variable in the latent variable recording unit 18B. Specifically, as explained in [1-1. Method of Generating Random Numbers] described above, a random number is generated according to the truncated normal distribution of the generation probability of the latent variable conditioned by the interval value shown in Expression (3) described above, and become an estimate of the latent variable. This truncated normal distribution is represented using a kernel function that represents similarity between input variables of the first input/output data, a kernel function that represents similarity between an input variable of the first input/output data and an input variable of the second input/output data, a kernel function that represents similarity between input variables of the second input/output data, and an interval value.

In step 104, the prediction unit 16 acquires an input variable x* for which the output variable value is unknown from the external device 30 via the input/output unit 20.

In step 106, the prediction unit 16 uses, as input, the unknown input variable x* the data D stored in the data recording unit 18A, and the latent variable stored in the latent variable recording unit 18B, and uses a Gaussian process to predict the value of the output variable y* for the unknown input variable x*. Specifically, the value of the output variable y* for the unknown input variable x* is predicted according to a predictive distribution represented using a Gaussian distribution that represents the posterior probability of the output variable for the unknown input variable x* given the value of the output variable of each of the first input/output data and the latent variable of each of the second input/output data. This predictive distribution is derived using Expression (5) described above as an example. Then, the prediction unit 16 outputs the obtained predicted value of the output variable y* to the external device 30 via the input/output unit 20, and ends the series of processes by this data analysis processing program.

Although a method of generating random numbers for the latent variables is used for approximate calculation of the posterior distribution of the output variables (including the integral with respect to latent variables) in the above embodiment, any method that approximates integral calculation may be used.

Note that as explained in [1-2. Method Using Approximation by Normal Distribution] described above, the truncated normal distribution of the generation probability of the latent variable conditioned by the interval value may be approximated by a normal distribution to obtain the predictive distribution. In this case, the latent variable estimation unit 14 estimates the mean and variance of the value of the output variable of each of the second input/output data based on the truncated normal distribution of the generation probability of the value in the interval value of each of the second input/output data. As described above, this truncated normal distribution is represented using a kernel function that represents similarity between input variables of the first input/output data, a kernel function that represents similarity between an input variable of the first input/output data and an input variable of the second input/output data, a kernel function that represents similarity between input variables of the second input/output data, and an interval value. Then, the prediction unit 16 predicts the value of the output variable y* for the unknown input variable x* according to the predictive distribution representing the posterior probability of the output variable y* for the unknown input variable x* given the value of the output variable of each of the first input/output data and the value conditioned by the interval value of each of the second input/output data based on a normal distribution obtained from the mean and variance of the value of the output variable of each of the second input/output data. This predictive distribution is represented using the normal distribution of the value of the output variable of each of the second input/output data. As an example, this predictive distribution is derived using an expression obtained by substituting the TN (truncated normal distribution) in Expression (4) described above with the approximated normal distribution.

### Second Embodiment

In this embodiment, a data analysis device in the case of implementing the second approach using two regression analyses will be described. Note that one of the methods of [2-1. Interposed Linear Regression], [2-2. Interposed Gaussian Regression], and [2-3. Interposed Gaussian Regression (When Scalar Value Is Treated as Interval Value)] described above is applied to the prediction of the output variable.

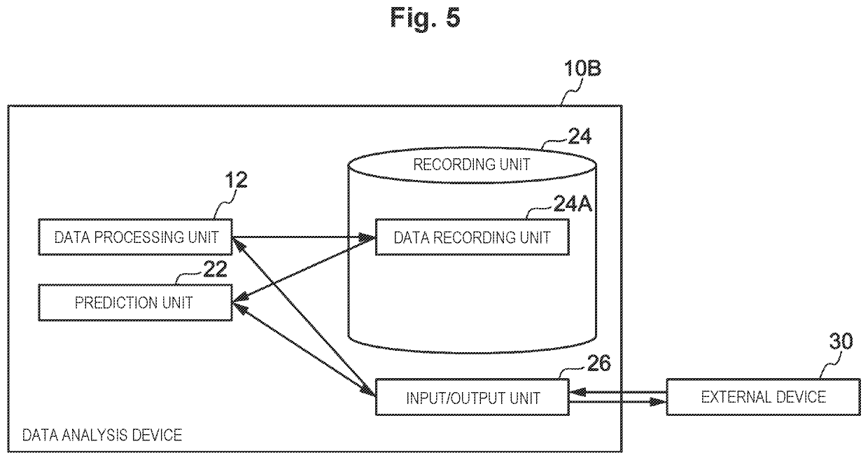

FIG. 5 is a block diagram showing an example of a functional configuration of a data analysis device 10B according to the second embodiment.

As shown in FIG. 5, the data analysis device 10B according to this embodiment is provided with the data processing unit 12, a prediction unit 22, a recording unit 24, and an input/output unit 26.

The data analysis device 10B is electrically configured as a computer device provided with a CPU, a RAM, a ROM, and the like, similar to the data analysis device 10; according to the first embodiment described above. Note that a data analysis processing program according to this embodiment is stored in the ROM.

The recording unit 24 is provided with a data recording unit 24A.

The input/output unit 26 is connected to the external device 30 via a network, receives input of data to be analyzed from the external device 30, and outputs the analyzed data to the external device 30.

The CPU functions as the data processing unit 12 and the prediction unit 22 described above by reading and executing the data analysis processing program stored in the ROM.

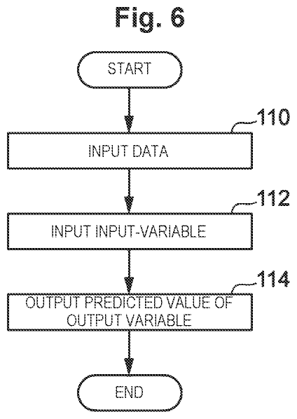

Next, the operation of the data analysis device 10B according to the second embodiment will be described with reference to FIG. 6. Note that FIG. 6 is a flowchart showing an example of a processing flow by the data analysis processing program according to the second embodiment.

In step 110 of FIG. 6, the data processing unit 12 acquires the data D described above from the external device 30 via the input/output unit 26, and stores it in the data recording unit 24A. Note that as described above, the data D is defined as data represented by a set of a plurality of first input/output data in which the value of the output variable is given and a plurality of second input/output data in which the value of the output variable is given as an interval value representing a range.

In step 112, the prediction unit 22 acquires an input variable x* for which the output variable value is unknown from the external device 30 the input/output unit 20.

In step 114, the prediction unit 22 uses, as input, the unknown input variable x* and the data D stored in the data recording unit 18A to predict the value of the output variable y* for the unknown input variable x*. Specifically, for example, as explained in [2-3. Interposed Gaussian Regression (When Scalar Value Is Treated as Interval Value)] described above, the value of the output variable of each of the first input/output data is set to the upper limit and the lower limit of the interval value of the output variable of each of the first input/output data. In this case, the value of the output variable y* for the unknown input variable x* is predicted according to the predictive distribution representing the posterior probability of the output variable for the unknown input variable x* given the value of the output variable of each of the first input/output data and the value conditioned by the interval value of each of the second input/output data. This predictive distribution is represented by a normal distribution that is represented using the mean of a firs t value and a second value and a variance represented using a kernel function that represents similarity between input variables of the first input/output data and the second input/output data. The first value is a mean that is represented using a kernel function for the upper limit of the interval value that represents similarity between the unknown input variable x* and each of the input variables of the first input/output data and the second input/output data, a kernel function for the upper limit of the interval value that represents similarity between input variables of the first input/output data and the second input/output data, and the upper limit of the interval value of the output variable of each of the first input/output data and the second input/output data. The second value is a mean that is represented using a kernel function for the lower limit of the interval value that represents similarity between the unknown input variable x* and each of the input variables of the first input/output data and the second input/output data, a kernel function for the lower limit of the interval value that represents similarity between input variables of the first input/output data and the second input/output data, and the lower limit of the interval value of the output variable of each of the first input/output data and the second input/output data. This predictive distribution is derived using Expression (10) described above as an example. Then, the prediction unit 22 outputs the obtained predicted value of the output variable y* to the external device 30 via the input/output unit 26, and ends the series of processes by this data analysis processing program.

Although the above embodiment uses a method of performing prediction using a simple mean of the values of two Gaussian processes, a weighted mean or a method of performing prediction using a more complicated function may be used.

Note that the method explained in [2-2. Interposed Gaussian Regression] described above may be used for the prediction of the output variable. In this case, the prediction unit 22 predicts the value of the output variable y* for the unknown input. variable x* according to the predictive distribution that represents the posterior probability of the output variable for the unknown input variable x* given the value of the output variable of each of the first input/output data and the value conditioned by the interval value of each of the second input/output data. This predictive distribution is represented using the posterior probability of the latent interval value for the unknown input variable x* given the value of the output variable of each of the first input/output data and the interval value of each of the second input/output data, and the posterior probability of the value of the output variable y* for the unknown input variable x* given the posterior probability of the latent interval value for the unknown input variable x* based on the kernel function for the upper limit of the interval value that represents similarity between input variables of the second input/output data, and the kernel function for the lower limit of the interval value that represents similarity between input variables of the second input/output data. This predictive distribution is derived using Expression (7) described above as an example.

Further, the method explained in [2-1. Interposed Linear Regression] described above may be used. In this case, the prediction unit 22 predicts the value of the output variable y* for the unknown input variable x* based on the unknown input variable and the data D using linear regression. Specifically, the prediction unit 22 predicts the value of the output variable y* for the unknown input variable x* according to the predictive distribution representing the posterior probability of the output variable for the unknown input variable x*. This predictive distribution is represented by a normal distribution that is represented based on a linear regression parameter (parameter wᵤ) that represents relationship between the input variable and the upper limit of the interval value of the output variable, a linear regression parameter (parameter wₗ) that represents relationship between the input variable and the lower limit of the interval value of the output variable, a weight parameter (parameter α) for each of the upper limit and the lower limit of the interval value, and a variance parameter (parameter β), which are estimated based on the first input/output data and the second input/output data, using a mean that is determined from a mean calculated from the unknown input variable x* using the linear regression parameter that represents relationship with the upper limit of the interval value, a mean calculated from the unknown input variable x* using the linear regression parameter that represents relationship with the lower limit of the interval value, and the weight parameter, and a variance that is represented using the weight parameter and the variance parameter. This predictive distribution is derived using Expression (6a) and Expression (6b) described above as an example.

The data analysis devices have been illustrated and described above as embodiments. The embodiments may be in the form of a program for causing a computer to function as each unit provided in the data analysis devices. The embodiments may be in the form of a computer-readable storage medium that stores this program.

In addition, the configurations of the data analysis devices described in the above embodiments are an example, and may be changed depending on the situation within a range not deviating from the spirit.

Further, the processing flows of the programs described in the above embodiments are also an example, and unnecessary steps may be deleted, new steps may be added, or the processing orders may be changed within a range not deviating from the spirit.

Further, the above embodiments have described the case where the programs are executed to implement the processes according to the embodiments by a software configuration using a computer, but they are not limited to this. The embodiments may be implemented by, for example, a hardware configuration or a combination of a hardware configuration and a software configuration.

### REFERENCE SIGNS LIST

10A, 10B Data analysis device

12 Data processing unit

14 Latent variable estimation unit

16, 22 Prediction unit

18, 24 Recording unit

20, 26 Input/output unit

30 External device

1. A data analysis device comprising:
a data processing unit that performs a process of acquiring data represented by a set of a plurality of first input/output data in which a value of an output variable is given and a plurality of second input/output data in which a value of an output variable is given as an interval value representing a range; and
a prediction unit that, based on an input variable for which a value of an output variable is unknown and the data, predicts a value of an output variable for the unknown input variable using a Gaussian process.

2. The data analysis device according to claim 1, further comprising
a latent variable estimation unit that estimates a latent variable representing an estimate of a true value of an output variable given as the interval value for each of the second input/output data,
the latent variable estimation unit generating a random number as the latent variable according to a truncated normal distribution of a generation probability of a latent variable conditioned by the interval value, the truncated normal distribution being represented using a kernel function that represents similarity between input variables of the first input/output data, a kernel function that represents similarity between an input variable of the first input/output data and an input variable of the second input/output data, a kernel function that represents similarity between input variables of the second input/output data, and the interval value,
wherein the prediction unit predicts a value of an output variable for the unknown input variable according to a predictive distribution represented using a Gaussian distribution that represents a posterior probability of an output variable for the unknown input variable given a value of the output variable of each of the first input/output data and the latent variable of each of the second input/output data.

3. The data analysis device according to claim 1, further comprising
a latent variable estimation unit that estimates a mean and variance of a value of the output variable of each of the second input/output data based on a truncated normal distribution of a generation probability of a value within the interval value of each of the second input/output data, the truncated normal distribution being represented using a kernel function that represents similarity between input variables of the first input/output data, a kernel function that represents similarity between an input variable of the first input/output data and an input variable of the second input/output data, a kernel function that represents similarity between input variables of the second input/output data, and the interval value,
wherein the prediction unit predicts a value of an output variable for the unknown input variable according to a predictive distribution representing a posterior probability of an output variable for the unknown input variable given a value of an output variable of each of the first input/output data and a value conditioned by the interval value of each of the second input/output data, the predictive distribution being represented using a normal distribution of a value of the output variable of each of the second input/output data, based on a normal distribution obtained from a mean and variance of a value of the output variable of each of the second input/output data.

4. The data analysis device according to claim 1, wherein the prediction unit
predicts a value of an output variable for the unknown input variable according to a predictive distribution representing a posterior probability of an output variable for the unknown input variable given a value of an output variable of each of the first input/output data and a value conditioned by the interval value of each of the second input/output data, the predictive distribution being represented using
a posterior probability of a latent interval value for the unknown input variable given a value of an output variable of each of the first input/output data and the interval value of each of the second input/output data, and
a posterior probability of a value of an output variable for the unknown input variable given a posterior probability of a latent interval value for the unknown input variable
based on a kernel function for an upper limit of the interval value that represents similarity between input variables of the second input/output data, and a kernel function for a lower limit of the interval value that represents similarity between input variables of the second input/output data.

5. The data analysis device according to claim 1, wherein the prediction unit
sets a value of an output variable of each of the first input/output data to an upper limit and a lower limit of an interval value of an output variable of each of the first input/output data, and
predicts a value of an output variable for the unknown input variable according to a predictive distribution representing a posterior probability of an output variable for the unknown input variable given a value of an output variable of each of the first input/output data and a value conditioned by the interval value of each of the second input/output data, the predictive distribution being represented by a normal distribution that is represented using:
a mean that is determined from:
a mean represented using a kernel function for an upper limit of the interval value that represents similarity between the unknown input variable and each of input variables of the first input/output data and the second input/output data, a kernel function for an upper limit of the interval value that represents similarity between input variables of the first input/output data and the second input/output data, and an upper limit of an interval value of an output variable of each of the first input/output data and the second input/output data; and
a mean represented using a kernel function for a lower limit of the interval value that represents similarity between the unknown input variable and each of input variables of the first input/output data and the second input/output data, a kernel function for a lower limit of the interval value that represents similarity between input variables of the first input/output data and the second input/output data, and a lower limit of an interval value of an output variable of each of the first input/output data and the second input/output data; and
a variance that is represented using a kernel function that represents similarity between input variables of the first input/output data and the second input/output data.

6. A data analysis device comprising:
a data processing unit that performs a process of acquiring data represented by a set of a plurality of first input/output data in which a value of an output variable is given and a plurality of second input/output data in which a value of the output variable is given as an interval value representing a range; and
a prediction unit that, based on an input variable for which a value of an output variable is unknown and the data, predicts a value of an output variable for the unknown input variable using linear regression,
wherein the prediction unit predicts a value of an output variable for the unknown input variable according to a predictive distribution representing a posterior probability of an output variable for the unknown input variable, the predictive distribution being represented by a normal distribution that is represented
based on a linear regression parameter that represents relationship between an input variable and an upper limit of an interval value of an output variable, a linear regression parameter that represents relationship between an input variable and a lower limit of an interval value of an output variable, a weight parameter for each of an upper limit and a lower limit of an interval value, and a variance parameter, which are estimated based on the first input/output data and the second input/output data,
using a mean that is determined from a mean calculated from the unknown input variable using a linear regression parameter that represents relationship with an upper limit of the interval value, a mean calculated from the unknown input variable using a linear regression parameter that represents relationship with a lower limit of the interval value, and the weight parameter, and
a variance that is represented using the weight parameter and the variance parameter.

7. A data analysis method comprising:
a step of a data processing unit performing a process of acquiring data represented by a set of a plurality of first input/output data in which a value of an output variable is given and a plurality of second input/output data in which a value of an output variable is given as an interval value representing a range; and
a step of a prediction unit predicting, based on an input variable for which a value of an output variable is unknown and the data, a value of an output variable for the unknown input variable using a Gaussian process.

8. A program for causing a computer to function as each unit provided in the data analysis device according to claim 1.
